(19) United States
(12) Patent Application Publication
(10) Pub. No.: US 2020/0268071 A1
(43) Pub. Date: Aug. 27, 2020

(54) Rapidly Deployable Face Mask

(71) Applicants: Jenna L. Newcomb, Duxbury, MA (US); Wayne L. Thornton, Hanson, MA (US); Lawrence P. Newcomb, Duxbury, MA (US)

(72) Inventors: Jenna L. Newcomb, Duxbury, MA (US); Wayne L. Thornton, Hanson, MA (US); Lawrence P. Newcomb, Duxbury, MA (US)

(21) Appl. No.: 16/284,696

(22) Filed: Feb. 25, 2019

(51) Int. Cl. A41D 13/11; B01D 39/16; B01D 39/08; B01D 46/52; A62B 18/02; A62B 23/02

(52) U.S. Cl. CPC A41D 13/1115; A41D 13/1169; B01D 39/1623; B01D 39/083; B01D 46/521; B01D 2239/065; A62B 23/025; B01D 2239/0613; B01D 2239/0618; B01D 2239/0407; A62B 18/025

(57) ABSTRACT

A rapidly deployable protective facemask includes a resilient member that self-expands to a deployed configuration when the mask is removed from its container.

### FIELD

The invention relates to a rapidly deployable, face-conforming, disposable and protective face mask.

### BACKGROUND

There are many instances in which it would be desirable to have a readily available face mask to protect oneself from sudden exposure to various harmful elements. For example, in order to avoid sudden exposure to dust and other particulate elements, smoke from a fire, bacteria and other potentially toxic materials, it would be desirable to have available a face mask to cover one's mouth and nose quickly in order to minimize the exposure to and inhalation of such material. Such a face mask desirably would have a peripheral construction adapted fit closely to and seal against the contour of the person's face and should be easily and rapidly positioned about the user's face. Additionally, the mask should be easily carried on one's person to be ready for emergency use as needed.

### SUMMARY

A face mask in accordance with the invention is formed from a plurality of layers of filtering materials, secured together at their peripheries, along the top, bottom and sides of the filtering layers. The side edges are provided with elastic strips that are secured to the side edges of the filtering layers. The strips are configured so that, when relaxed, they will be shorter than the sides of the filtering layers so that when the mask is donned, the elastic strips will cause the side edges of the mask to lie snug against the user's face. The mask is constructed to be collapsible into a compact, small volume container that is easily carried on one's person. In order to facilitate rapid deployment of the face mask, a strip of a pre-formed elastomeric material extends from one side of the mask to the other and is configured to self-expand from a compacted configuration in which the mask can be contained in a container, to deployed shape that can be applied directly to the user's face with a minimum of manipulation. The mask is provided with adhesive strips along the top edge of the mask to enable the mask to be adhesively secured to the bridge of the user's nose and also includes adhesive strips along the bottom edge to attach the mask about the region of the chin. The mask may be deployed without requiring tie straps or ear loops.

### THE DRAWINGS

The various objects and advantages of the invention will be appreciated more fully from the following description of an illustrative embodiment of the invention, with reference to the accompanying drawings in which:

FIG. 1 is an exploded, isometric view of the layers of a face mask in an illustrative embodiment of the invention;

FIG. 2 is a plan view of the front face of the outer layer of the face mask of FIG. 1;

FIG. 3 is a plan view of the inner face of the inner layer of the mask of FIG. 1;

FIG. 4 is a longitudinal cross section of the mask taken through the preformed self-deploying elastomeric strip;

FIG. 4A is an enlarged portion of the sectional illustration of FIG. 4 as seen through a portion of the deployment band and a butterfly exhaust valve;

FIG. 5 is an enlarged cross-sectional illustration of a side margin of the face mask;

FIG. 6 is an illustration of the mask in an accordion-like folded configuration;

FIG. 7 is a diagrammatic illustration of the accordion-folded mask again folded in half along its length and contained in a reduced-dimension container; and

FIG. 8 is a side view of the self-deployed mask when removed from the constraint of the container.

### ILLUSTRATIVE EMBODIMENT

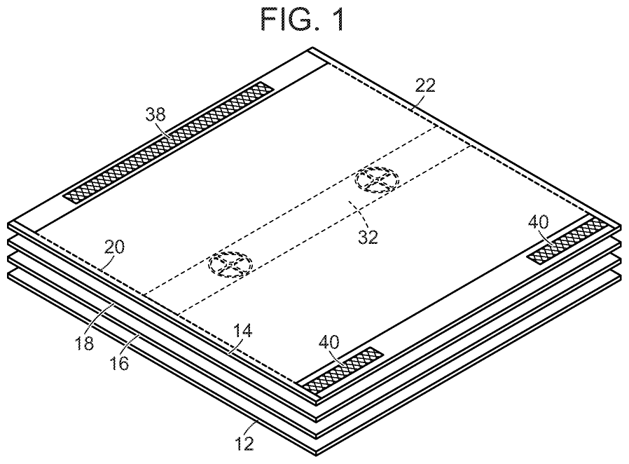

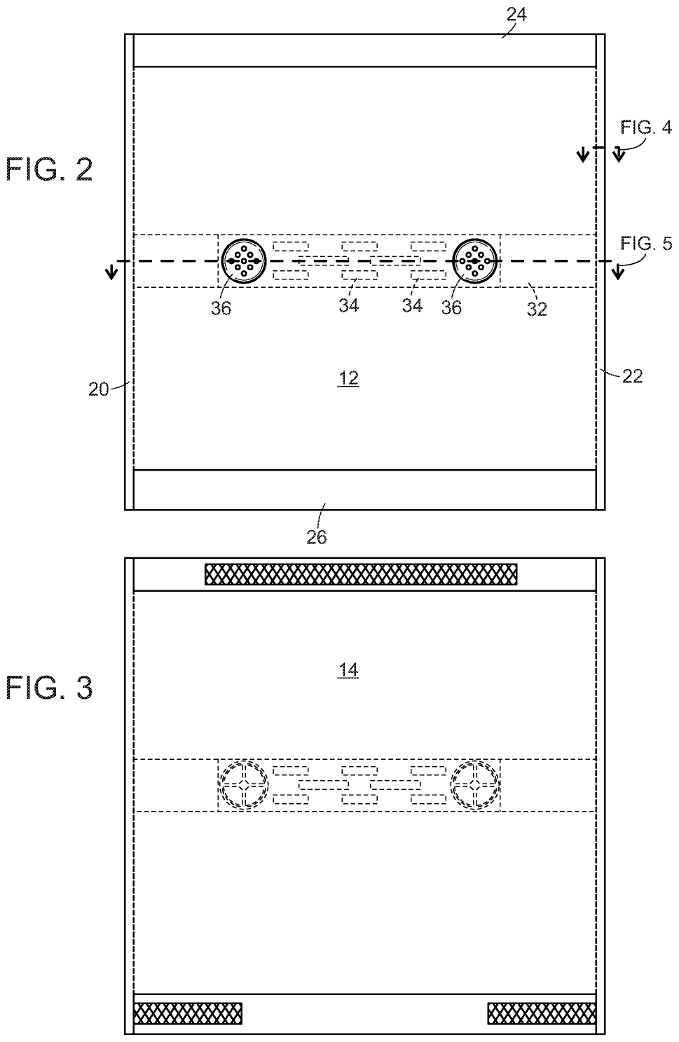

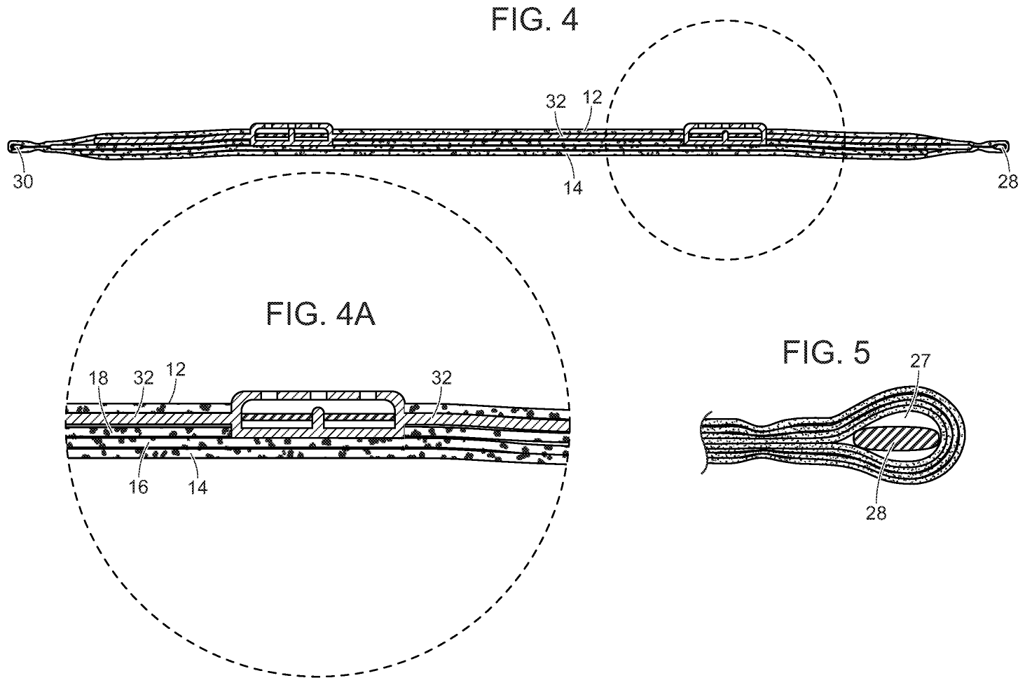

FIG. 1 illustrates, in exploded view, the layers of an embodiment of the face mask 10. The mask 10 includes a plurality of layers of air-permeable sheet material, the number and types of sheet material being dependent, in part, on the types of contaminant or toxic material to be filtered. By way of example only, a general-purpose mask 10 may have four filter sheets including an outer layer 12 that is to be exposed to the environment, an inner layer 14 that faces the user and one or more internal layers 16, 18 between the inner and outer layers. For example, the outer layer 12 may be adapted to trap the largest dust particles or the like having an effective diameter of the order of about five microns or larger and may be formed from a woven or non-woven material. The inner layer 14 may be selected to satisfy High Efficiency Particulate Air (HEPA) standards, to filter out particles less than about 0.5 microns in size. The inner layer 14 may be formed from woven or non-woven material that may have electrostatically charged fibers to attract airborne particulates such as pollen, building dust, clay dust, grain dust, soya dust, carbon dust, house dust, cigarette smoke PM 10s, diesel smoke, lead, tar and the like. One of the internal sheets 16 may be selected to filter particles about 1.5-2 microns in size and may be a non-woven or woven fabric that is impregnated with absorptive charcoal for protection against chemical and bacterial material. The other sheet 18 may be a medical grade woven or non-woven polypropylene and may be laminated about its margins to the margins of the sheet 16. The laminated sheets 16, 18 provide protection against hydrocarbons, acid gases, photochemical pollutants, ozone as well as particulates. The sheets may be formed from various materials commonly used in the manufacture of face masks such as nonwoven spunbonded materials, cellulose, synthetic fibers and the like as will be understood by those familiar with the art.

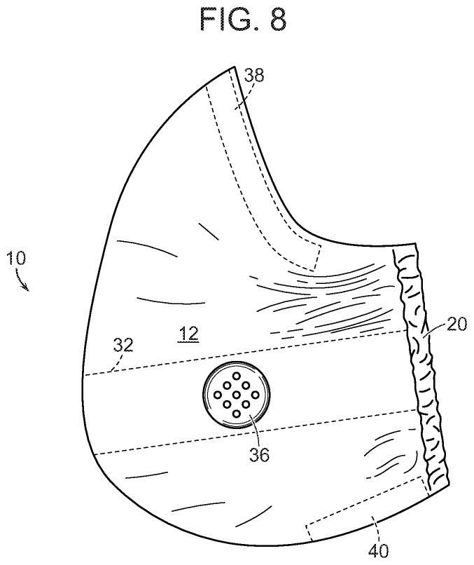

The sheets preferably are the same size and are rectangular, for example, of the order of about 6.5 inches by about 7 inches wide, having heat sealed or otherwise secured side margins 20, 22 and top and bottom margins 24, 26, respectively. The side margins 20, 22 may be folded to define a pair of elongate pockets 27 (FIG. 5), each of which contains an elastic ribbon or band 28, 30. The elastic bands 28, 30, when relaxed, are shorter in length than the sides 20, 22 of the mask but are stretched when the mask is assembled with the ends of the bands 28, 30 being secured within the pockets to the margins so that the bands will draw each of the sides into a curved configuration that can closely follow the contour of the user's face as shown in FIG. 8. The ends of the bands 28, 30 may be secured in the mask as by an adhesive bond. When the mask is applied to the user's face, the bands 28, 30 can stretch and flex to conform to and seal against the user's facial contour.

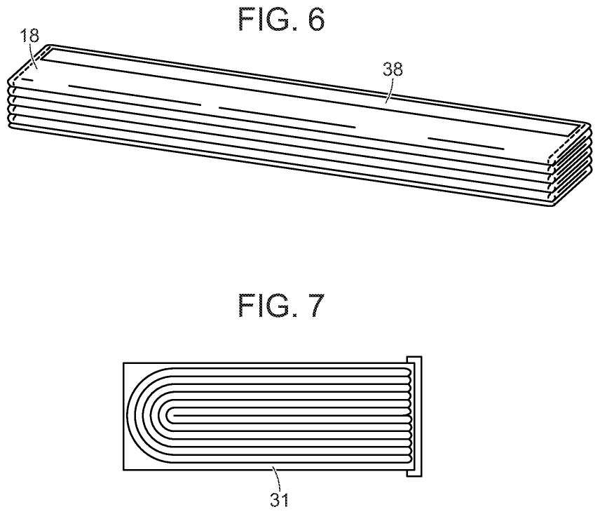

As will be described, the mask is formed so that it can be folded into a compact configuration containable in a small, easily-carried container 31. The mask may be folded in an accordion-like manner (FIG. 6) and then folded in half (FIG. 7) so as to be containable in the container 31. In order to facilitate donning of the mask with a minimum of manipulation, the mask includes an elastomeric deployment band 32 that is adapted to self-deploy from a compacted shape to a predetermined deployed shape when the mask is removed from the container. The deployment band 32 spreads the side margins of the mask apart so that the mask is opened (FIG. 8) and ready to be donned. The deployment band 32 is formed from a suitable elastomeric material and extends from one side margin 20 to the other side margin 22. The deployment band may be substantially straight when relaxed or may be formed to have have a curved configuration in its relaxed state. Preferably, it is attached to the inner surface of the outer layer 12 or laminated at its ends between the outer layer 12 and the next innermost layer 18. The deployment band 32 may be provided with a number of openings 34 to reduce the weight of the mask without affecting its ability to self-deploy as described. The deployment band may be about ⅝^{th} inch wide and should have a thickness as small as possible while still being able to cause the mask to self-expand when the mask is removed from its container. The band 32 should be thin enough so as not to adversely affect the ability of the mask to be folded as described below. By way of example, the band 32 may be of the order of about one millimeter or less in thickness, depending on the selection of elastomer for the band 32.

In order to allow exhaustion of moist air from within the mask, the mask may be provided with one or more one-way exhaust valves 36. In the illustrative embodiment, two such valves 36 are shown, each one being mounted to the deployment band and with the exhaust side of the valve protruding through the outermost layer 12. The exhaust valves preferably are of the butterfly type. Such butterfly valves are commercially available from a number of sources. The valves allow exhaled moist gas to exit the mask, thus preventing moisture to accumulate within the mask.

When the mask is donned, the elastic ribbons at the side margins and the deployment band 32 cause the mask to assume a pouch configuration as suggested in FIG. 8. In order to secure the mask about the region of the user's nose, a flexible adhesive strip 38 preferably is provided along the upper margin of the inner-most surface of the mask. The length of the strip preferably is sufficient to extend over the bridge of the nose and at least partly along the upper cheeks of the user. The adhesive should be adapted to attach to the user's skin to hold that portion of the mask in place as well as to effect a seal. The adhesive strip 38 is covered with a non-adhesive protective strip that is easily removed just before applying the mask to the face. Similarly, one or more chin adhesive strips 40 may be provided along the lower margin of the mask to secure and seal the lower portions of the mask to the user's face.

The mask is easily folded into a compact elongate, accordion-like configuration (FIG. 6) and then folded along its length (FIG. 7) so that it can be contained in a small package 31 that is easily carried on one's person in readiness for use.

The mask may be provided, optionally, with tie straps or ear loops, although the foregoing construction is considered to be attachable to a user's face without such additional features.

From the foregoing, it will be appreciated that the invention provides a protective face mask that is adapted for use in potentially hazardous environments and which can be deployed rapidly with a minimum of manipulation. It should be understood, however, that the foregoing description of the invention is intended merely to be illustrative thereof and that other embodiments, modifications and equivalents may be apparent to those skilled in the art without departing from the principles of the invention.

I claim:

1. A face mask comprising:
a plurality of flexible layers of air-permeable filtering material secured together, the mask having an upper margin, a lower margin and transversely disposed side margins;
the mask having a deployed configuration in which it can be placed over the user's face, the mask being foldable to a compact configuration containable in a package having smaller dimensions than those of the unfolded face mask;
an elastic deployment band attached to at least one of the layers and extending transversely of the mask when the band is unstressed, the deployment band having sufficient resiliency so that when the mask is removed from the package, the deployment band will self-expand to its unstressed state, thus causing the face mask to expand to its deployed configuration.

2. The face mask as defined in claim 1 further comprising:
an elastic band attached to each of the side margins, each elastic band, when relaxed, being shorter in length than its associated side margin, each band being attached at its ends to its associated side margin at spaced locations that are farther apart than the length of the relaxed elastic band.

3. The face mask as defined in claim 2 further comprising:
each of the side margins being folded to define an elongate pocket, each elastic band being contained fin its associated pocket.

4. The face mask as defined in claim 1 further comprising:
a one-way exhaust valve mounted to the deployment band and extending through the layers disposed forwardly of the deployment band to enable exhaled air to be exhausted from within the mask.

5. The face mask as defined in claim lwherein at least one of the layers is a HEPA filter adapted to entrap particles less than about 0.5 microns in size.

6. The face mask as defined in claim 1 wherein at least one of the layers is impregnated with an absorptive medium.

7. The face mask as defined in claim 1 wherein the deployment band is substantially straight when relaxed.

8. The face mask as defined in claim 1 wherein the deployment band is curved when relaxed.

9. The face mask as defined in claim 1 wherein the mask in foldable in a plurality of accordion-like pleats that substantially parallel the deployment band.

10. The face mask as defined in claim 10 wherein the folded mask is again foldable in half along its length and further comprising a container to contain the double-folded mask.

11. The face mask as defined in claim 1 further comprising an adhesive nose strip attached to the top margin of the mask and extending towards the side margins, the adhesive nose strip being covered with a protective film that is removable to expose the adhesive, the adhesive being adapted to be removably attachable to the skin to effect a seal against the skin.

12. The face mask as defined in claim 11 further comprising at least one adhesive chin strip extending along the bottom margin of the mask and being covered by a protective film that is removable to expose the adhesive, the adhesive being adapted to be removably attachable to the skin to effect a seal against the skin.

13. The face mask as defined in claim 1 further comprising tie straps attached to each of the side margins.

14. The face mask as defined in claim 1 further comprising an ear loop attached to each side margin of the face mask.
